(19) United States
(12) Patent Application Publication
(10) Pub. No.: US 2026/0008380 A1
(43) Pub. Date: Jan. 8, 2026

(54) Rooftop magazine type swappable tank and outboard battery module plug in hybrid hydrogen and battery electric vehicle

(71) Applicant: Yonghua Wang, Klamath Falls, OR (US)

(72) Inventor: Yonghua Wang, Klamath Falls, OR (US)

(21) Appl. No.: 18/831,095

(22) Filed: Jul. 5, 2024

(51) Int. Cl. B60L 53/80

(52) U.S. Cl. CPC B60L 53/80

(57) ABSTRACT

A hybrid plug-in battery, rooftop “magazine” type swappable hydrogen tank package, and outboard “magazine” type swappable battery bank Electric Vehicle comprises: 1) a plug-in full electric vehicle; 2) a rooftop “magazine” type swappable hydrogen tank package; 3) a outboard “magazine” type swappable battery bank; wherein the rooftop “magazine” type swappable hydrogen tank package is electrically connected to the battery bank of the plug-in full electric vehicle the second power source, and the outboard “magazine” type swappable battery bank is electrically connected to the battery bank of the plug-in full electric vehicle the third power source, so that the vehicle can be charged by using any existing charging stations through the plug-in full electric vehicle, get energy replenished by exchanging the hydrogen tanks through the rooftop “magazine” type swappable hydrogen tank package, and get energy replenished by exchanging the battery modules through the outboard “magazine” type swappable battery bank.

### TECHNICAL FIELD

The present disclosure relates generally to hybrid battery and hydrogen fuel cell electric vehicles, and more specifically, to rooftop magazine type swappable hydrogen tank and outboard battery module plug in hybrid hydrogen and battery electric vehicle (EV).

### BACKGROUND

The Sun provides Earth with as much energy every hour as human civilization uses every year (O. Morton, 2006, “Silicon Valley Sunrise”, Nature, 443, Sep. 7, 2006). If a tiny fraction of those sun rays were captured and used in place of fossil fuels, there would be no need for power plants with environmentally disastrous greenhouse gas emissions. The rapid technology progress in recent years also ushers a renewable energy dominated new era. However, due to the intermittence of most renewable energies, the entire world is facing to a grand challenge in transition from the fossil fuel dominated energy utilization pattern to renewable energy dominated energy utilization pattern. For example, the transportation is accelerating in transition from the internal combustion engine based vehicle to electric motor based vehicle. Among the three major energy consumption sectors, power grid system, building, and transportation, transportation mainly relies on battery and hydrogen as energy storage mediums to smooth the intermittence of renewable energies. Theoretically, hydrogen is one of the best approached to address the intermittence of renewable energy. However, in order to enhance the wide-spread adoption of hydrogen based vehicles, widely distributed hydrogen supply infrastructure must be in place. It is unbelievable to construct the wide-distributed hydrogen supply infrastructure before the hydrogen based vehicles are widely adopted. Currently, battery based vehicles are dominated on the EV market because the power grid infrastructure for charging EV is already available. However, the lengthy charging time of battery and the safety concern of lithium based battery, which is the major type of traction battery of current EVs, hindered the wide-spread adoption of EVs.

The current hydrogen storage, transportation, and distribution system is based on centralized large scale high pressure tanks. The generated hydrogen is charged into centralized large scale high pressure tanks for storage, then the stored hydrogen is charged to centralized tanks of trucks for transportation, and finally the transported hydrogen is charged into centralized tanks in charging stations for further charging hydrogen vehicles. During the entire process, multiple charging processes involve in the hydrogen storage, transportation and distribution making the process intricate and significantly increasing the risks of causing safety issues. The present invention creates a method to use modular hydrogen tanks to replace the centralized tanks for storage, transportation, and distribution of hydrogen to avoid charging processes. The modular swappable hydrogen tanks are equipped with wireless communication electronic terminals with sensors for sharing. Furthermore, the present invention creates a hybrid plug-in battery and hydrogen vehicle to complete the process from hydrogen generation to hydrogen utilization. The present invention also creates a mechanism to easily convert a full electric vehicle into hybrid hydrogen and battery vehicle through combining swappable fuel cell modules and swappable hydrogen tanks.

Current approach in addressing the issue of lengthy charging time is to extend the range of EV for once battery charging by expanding battery bank. This approach not only dramatically increases the cost of EVs, but also significantly raises the weight of vehicles. In addition, the expanded dimension of lithium ion battery banks prominently increases the risk capturing fire. One of the other approaches in addressing the issue of lengthy charging time is battery bank swapping. Current battery bank swapping is implemented through swapping stations where the entire battery bank of EV is swapped as a single entity. Since battery swapping stations occupy lands and their construction is expansive, station swapping of battery is not widely adopted. However, battery swapping approach was approved effective in addressing the issue of lengthy charging time, and demonstrated an effective way to address the energy storage issue of solar power generation through sharing battery. The present invention creates a method to swap outboard battery bank or modules in parking lots or anywhere rather than swapping stations. The outboard battery bank containing battery modules can be swapped as a single entity or through the battery modules.

Overall, the present invention discloses a hybrid hydrogen fuel cell and battery EV with swappable fuel cell modules and hydrogen tanks and swappable battery modules comprising a plug-in full EV, a rooftop swappable package with fuel cell modules and swappable hydrogen tanks, and an outboard swappable battery bank with swappable battery modules. With this configuration, the EV of the present invention can be charged with any charging stations, get fuel cell and hydrogen tank package or hydrogen tanks swapped anywhere, and get battery bank or battery modules swapped anywhere. The EV of the present invention can not only make full use of the existing charging station network infrastructure, but also facilitate the establishment of hydrogen supply infrastructure. Furthermore, the EV of the present invention enables battery swapping anywhere without battery swapping stations. Through sharing the battery modules and hydrogen tanks, the present invention can help to address the energy storage issue of solar power generation and hydrogen storage, transportation, and distribution issues.

The configuration of the present invention not only enables small battery bank, but also makes it possible to adopt batteries such as sodium ion battery with lower energy density. By adopting sodium ion battery, the present invention can substantially eliminate the safety concern of lithium ion battery. The synergistically combination of hydrogen fuel cells and battery banks of can not only substantially improve the overall efficiency, but also significantly reduce the cost of EVs.

U.S. Pat. No. 8,963,481 B2 granted to Prosser et al (Prosser) disclosed charging service vehicles and methods using modular batteries. In Prosser's disclosure, modular batteries are delivered to battery swappable EVs to replace the exhausted modular batteries. Although Prosser's vehicle is equipped with charging system, their vehicle is not powered by their modular batteries. Prosser's battery modules are mounted onboard of vehicle and can only be swapped individually. The present invention discloses an outboard swappable “magazine” type battery bank with swappable battery modules, which includes a swappable container and swappable battery modules contained in the container. Battery can be swapped by swapping the container as a single entity, or swapping the battery modules individually without swapping the container.

U.S. Pat. No. 11,828,417 B2 granted to Clarke et al (Clarke) disclosed Systems and Methods for Storing, Transporting, and Using Hydrogen. Clarke disclosed a swappable package with modular hydrogen tanks, but there is no fuel cell units integrated into the package. The present invention discloses a swappable “magazine” type fuel cell and hydrogen tank package, which includes a container integrated with fuel cell units and swappable hydrogen tanks. Hydrogen tanks can be swapped through swapping the entire package as a single entity or swapping the hydrogen tanks individually without swapping the container.

US20220041299 A1 filed by Wankewycz et al (Wankewycz) disclosed Unmanned Vehicle. Wankewycz disclosed swappable hydrogen tank system for hydrogen airplane. In Wankewycz system, all modular hydrogen tanks are not packed in a package and therefore can only be swapped individually.

### SUMMARY

According to the present invention, the disclosed hybrid hydrogen and battery EV comprises a plug-in full electric vehicle, a “magazine” type rooftop swappable fuel cell and hydrogen tank package, and a “magazine” type swappable outboard battery bank with swappable battery modules. Wherein, the “magazine” type rooftop swappable fuel cell and hydrogen tank package is mounted on the top of the plug-in full electric vehicle, and the “magazine” type swappable outboard battery bank with swappable battery modules is mounted outside of the rear door of the plug-in full electric vehicle. The “magazine” type rooftop swappable fuel cell and hydrogen tank package and the “magazine” type swappable outboard battery bank are electrically connected to the battery bank of the plug-in full electric vehicle as the second and third power sources. Any existing plug-in full electric vehicles can be easily retrofitted into the hybrid hydrogen and battery electric vehicles of the present invention by adding the “magazine” type rooftop swappable fuel cell and hydrogen tank package and the “magazine” type swappable outboard battery bank of the present invention.

Through the “magazine” type rooftop swappable fuel cell and hydrogen tank package, the present invention successfully circumvents the construction of hydrogen supply infrastructure for hydrogen vehicle and provides hydrogen transporting, distributing, and utilizing method.

Through “magazine” type swappable outboard battery bank, the present invention radically addresses the lengthy time charging issue of EVs and enables battery swapping anywhere.

Through the hybrid hydrogen and battery electric vehicle, the present invention radically addresses the intermittence issue of solar power generation system and other renewable energy power generation systems.

Through the hybrid hydrogen and battery electric vehicle, the present invention radically addresses the safety issue of lithium battery and the issue of limited lithium reserve, and provides an opportunity to synergistically coordinate the hydrogen power system and battery power system to improve vehicle efficiency. In addition, the present invention enables full uses of all energy replenish infrastructures.

The present invention provides a mechanism to pair the distributed EV power demand and the distributed renewable energy power supply without power grid. It also provides a possibility to establish a mobile power supply network and charge EVs anywhere.

Further aspects and advantages of the present invention will become apparent upon consideration of the following description thereof, reference being made of the following drawing.

### BRIEF DESCRIPTION OF THE DRAWINGS

The accompanying drawings, which are incorporated in and constitute a part of this specification, illustrate an embodiment of the invention and together with the description, serve to explain the principles of the invention.

FIG. 1 is the schematic indication of the hybrid plug-in battery, rooftop “magazine” type swappable hydrogen tank package, and outboard “magazine” type swappable battery bank Electric Vehicle.

FIG. 2 is the system structure of the rooftop “magazine” type swappable hydrogen tank package.

FIG. 3 is the cross section view of the outboard “magazine” type swappable battery bank.

### DETAILED DESCRIPTION

Reference will now be made in detail to the present exemplary embodiments, examples of which are illustrated in the accompanying drawings. Wherever possible, the same reference numbers will be used throughout the drawings to refer to the same or like parts.

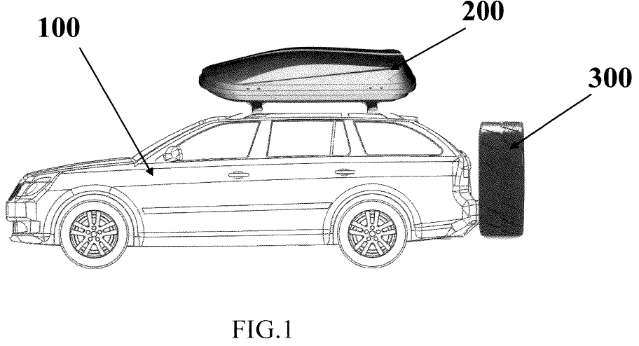

Referring to FIG. 1, hybrid plug-in battery, rooftop “magazine” type swappable hydrogen tank package, and outboard “magazine” type swappable battery bank Electric Vehicle comprises a plug-in full electric vehicle 100, a rooftop “magazine” type swappable hydrogen tank package 200, and outboard “magazine” type swappable battery bank 300, wherein the rooftop “magazine” type swappable hydrogen tank package 200 is electrically connected to the battery bank of the plug-in full electric vehicle 100 the second power source, and the outboard “magazine” type swappable battery bank 300 is electrically connected to the battery bank of the plug-in full electric vehicle 100 the third power source, so that the vehicle can be charged by using any existing charging stations through the plug-in full electric vehicle, get energy replenished by exchanging the hydrogen tanks through the rooftop “magazine” type swappable hydrogen tank package, and get energy replenished by exchanging the battery modules through the outboard “magazine” type swappable battery bank.

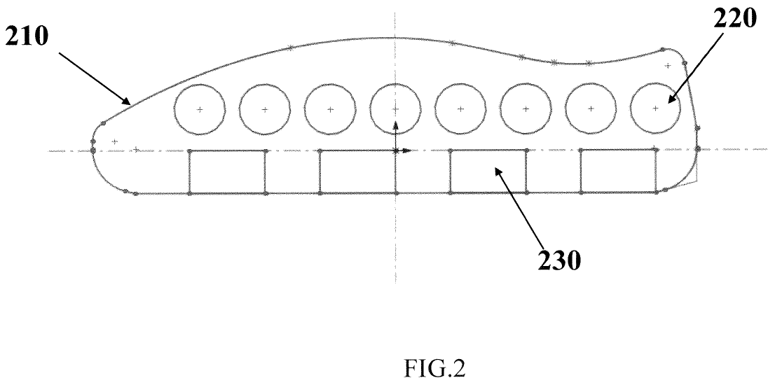

Referring to FIG. 2, the rooftop “magazine” type swappable hydrogen tank package comprises a container 210, one or more fuel cell modules 220, and one or more hydrogen tanks 230, wherein the hydrogen tanks can be swapped through swapping the entire package as a single entity or swapping the hydrogen tanks individually.

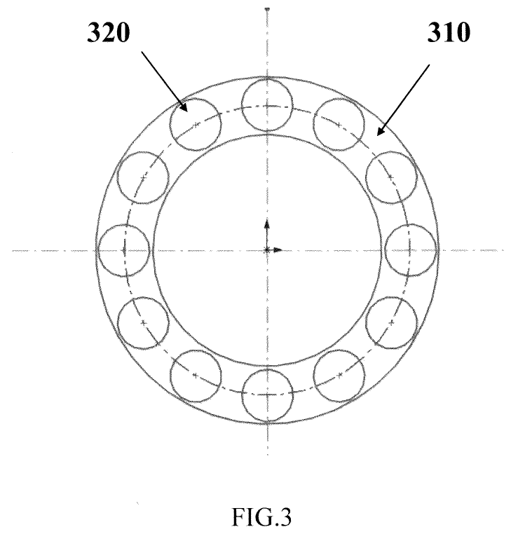

Referring to FIG. 3, the outboard “magazine” type swappable battery bank comprises a container 310 and one or more battery modules 320, wherein the battery modules can be swapped through swapping the entire bank as a single entity or swapping the battery modules individually.

From the description above, a number of advantages of the hybrid plug-in battery, rooftop “magazine” type swappable hydrogen tank package, and outboard “magazine” type swappable battery bank Electric Vehicle (hybrid vehicle) becomes evident. The hybrid vehicle can not only use all existing electric charging infrastructure, but also creates possibility to establish mobile hydrogen supply infrastructure and mobile battery swapping infrastructure. Through sharing hydrogen tanks and battery modules, the hybrid vehicle not only provide an approach to address the energy storage issue of renewable energy power generation systems, but also provides an energy utilization method highly matched with renewable energies. The hybrid vehicle provides an unparallel approach to radically address the lengthy charging issue of EV, and a possibility to combine hydrogen and battery to reduce overall cost and improve efficiency of EVs. The hybrid vehicle paves the road for wide-spread adoption of sodium ion battery. The hybrid vehicle enables both hydrogen tank and battery module swapping at swapping stations and anywhere else without swapping stations. The hybrid vehicle provides an easy way to retrofit any full electric vehicles into hybrid hydrogen and battery vehicles. The hybrid vehicle can take advantages of hybrid internal combustion engine and battery motor but without consumption of fossil fuel.

In the preceding specification, various preferred embodiments have been described with reference to the accompanying drawings. It will, however, be evident that various other modifications and changes may be made thereto, and additional embodiments may be implemented, without departing from the broader scope of the invention as set forth in the claims that follow. The specification and drawings are accordingly to be regarded in an illustrative rather than restrictive sense.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

I claim:

1. A hybrid plug-in battery, rooftop “magazine” type swappable hydrogen tank package, and outboard “magazine” type swappable battery bank Electric Vehicle comprises: 1) a plug-in full electric vehicle; 2) a rooftop “magazine” type swappable hydrogen tank package; 3) a outboard “magazine” type swappable battery bank; wherein the rooftop “magazine” type swappable hydrogen tank package is electrically connected to the battery bank of the plug-in full electric vehicle the second power source, and the outboard “magazine” type swappable battery bank is electrically connected to the battery bank of the plug-in full electric vehicle the third power source, so that the vehicle can be charged by using any existing charging stations through the plug-in full electric vehicle, get energy replenished by exchanging the hydrogen tanks through the rooftop “magazine” type swappable hydrogen tank package, and get energy replenished by exchanging the battery modules through the outboard “magazine” type swappable battery bank.

2. The hybrid plug-in battery, rooftop “magazine” type swappable hydrogen tank package, and outboard “magazine” type swappable battery bank Electric Vehicle of claim 1, wherein the rooftop “magazine” type swappable hydrogen tank package comprises a container, one or more fuel cell modules, and one or more hydrogen tanks, wherein the hydrogen tanks can be swapped through swapping the entire package as a single entity or swapping the hydrogen tanks individually.

3. The hybrid plug-in battery, rooftop “magazine” type swappable hydrogen tank package, and outboard “magazine” type swappable battery bank Electric Vehicle of claim 1, wherein the outboard “magazine” type swappable battery bank comprises a container and one or more battery modules, wherein the battery modules can be swapped through swapping the entire bank as a single entity or swapping the battery modules individually.
